(19) United States
(12) Patent Application Publication
(10) Pub. No.: US 2007/0003711 A1
(43) Pub. Date: Jan. 4, 2007

(54) Polarizing film, liquid crystal display including polarizing film, and manufacturing method thereof

(75) Inventors: In-Sun Hwang, Suwon-si (KR); Hae-Ik Park, Seoul (KR); Joong-Hyun Kim, Suwon-si (KR); Sang-Yu Lee, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/471,448

(22) Filed: Jun. 20, 2006

(30) Foreign Application Priority Data
Jul. 1, 2005 (KR) 10-2005-0059089

(51) Int. Cl. C09K 19/00

(52) U.S. Cl. 428/1.31; 428/323

(57) ABSTRACT

A liquid crystal display according to the present invention comprises a first panel, a second panel facing the first panel, a liquid crystal layer disposed between the first panel and the second panel, and a polarizing film, wherein the polarizing film includes electrically conductive particles (e.g., carbon nanotubes or carbon nanofibers) and reflects a first polarization component parallel to the alignment direction of the electrically conductive particles and transmits a second polarization component perpendicular to the alignment direction of the electrically conductive particles.

### CROSS-REFERENCE TO RELATED APPLICATION

This application claims priority, under 35 U.S.C. § 119, of Korean Patent Application No. 10-2005-0059089 filed in the Korean Intellectual Property Office on Jul. 1, 2005, the entire contents of which are incorporated herein by reference.

### BACKGROUND OF THE INVENTION

1. Field of the Invention

The present invention relates to a polarizing film, a liquid crystal display including a polarizing film, and a manufacturing method thereof.

2. Description of Related Art

Generally, a liquid crystal display (LCD) includes a liquid crystal (LC) layer interposed between a pair of display panels that are each equipped with field-generating electrodes and polarizers.

The field-generating electrodes for each pixel generate an electric field across the liquid crystal layer, and the variation of the strength of the electric field in each pixel changes orientations of liquid crystal molecules in the liquid crystal layer.

The change of orientations of the liquid crystal molecules in the liquid crystal layer changes the polarization of light that passes through the liquid crystal layer.

The polarizers appropriately block or transmit the variously polarized light to make bright and dark regions so as to display a desired image.

Generally, a conventional polarizer includes a polarizing film made from materials such as polyvinyl alcohol (PVA).

The polarizing film may be formed by drawing (stretching) a polyvinyl alcohol (PVA) in a predetermined direction after dying it with anisotropic uric compounds or by arranging molecules of dichromatic dye in a predetermined direction after adsorbing the dye to PVA.

The polarizer formed in this way absorbs the light component having a linear polarization parallel to the above-described predetermined direction (a polarization component parallel to the above-described predetermined direction), while it transmits a polarization component perpendicular to the predetermined direction.

Alternatively, the conventional polarizing film can be made by patterning metal pieces to extend in a predetermined direction. The metallic polarizing film manufactured in this way reflects a polarized light component parallel to the extending direction and transmits a polarized light component perpendicular to the extending direction.

A liquid crystal display, which is a non-emissive display device, allows the light from a lamp of a separately equipped backlight unit pass through the liquid crystal layer in varying intensities in each pixel.

Accordingly, it is preferable that the polarizers attached to the liquid crystal display, and especially the polarizer disposed near the backlight unit of the liquid crystal display, does not absorb the light emitted from the backlight unit but rather reflects it.

It is very difficult and expensive to make a polarizing film by patterning a metal because of the precise and fine pattern required.

The above information disclosed in this Background section is only for enhancement of understanding of the background of the invention and therefore it may contain information that does not form the prior art that is already known in this country to a person of ordinary skill in the art.

### SUMMARY OF THE INVENTION

A Liquid crystal display having a polarization member (polarizing film) according to an exemplary embodiment of the present invention includes a base film, a ground (electrically conductive)_layer disposed on the base film and a plurality of electrically conductive particles disposed in the electrically conductive layer.

A method of manufacturing a polarization member (polarizing film) for an LCD according to an exemplary embodiment of the present invention includes: coating a mixture including a liquid crystal material and electrically conductive particles on a base layer (e.g., a base film) to form a polarizing film; and hardening (polymerizing) the polarizing film.

A liquid crystal display according to an exemplary embodiment of the present invention includes a first panel, a second panel facing the first panel, a liquid crystal layer disposed between the first panel and the second panel, and a first polarizing film (e.g. disposed at the first panel and) including electrically conductive particles.

The liquid crystal display further comprises a second polarizing film disposed at the second panel and including electrically conductive particles.

The first panel comprises a substrate and a plurality of thin films on the substrate, wherein the polarizing film contacts the substrate or is disposed between the thin films or on the thin films.

The thin films may comprise a gate line and a data line disposed on the substrate, a thin film transistor connected to the gate line and the data line and a pixel electrode connected to the thin film transistor. The thin films comprise a common electrode formed on an entire surface of the substrate.

The thin films further comprise a light blocking member disposed on the substrate. The thin films further comprise a color filter disposed on the substrate.

The electrically conductive particles may be spaced apart from each other at a distance of about 50 nm to about 150 nm.

The electrically conductive particles may comprise a carbon nano tube or a carbon nano fiber. The electrically conductive particles may be cylindrical. The electrically conductive particles may have a length equal to about 500 nm to about 900 nm and a width equal to about 30 nm to about 90 nm.

The present invention now will be described more fully hereinafter with reference to the accompanying drawings, in which preferred embodiments of the invention are shown. The present invention may, however, be embodied in many different forms and should not be construed as limited to the embodiments set forth herein.

### BRIEF DESCRIPTION OF THE DRAWINGS

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present. In the drawings:

FIG. 1 is a perspective view of a liquid crystal display according to an embodiment of the present invention;

FIG. 2A is a top plan view of the polarizing film shown in FIG. 1;

FIG. 2B is a expanded view of a portion of the polarizing film shown in FIG. 2A;

FIG. 2C is a cross-sectional view of the polarizing film shown in FIG. 2B taken along the section line IIC-IIC. FIG. 3 is a perspective view of an exemplary electrically conductive particle contained in the polarizing film;

FIG. 4A, FIG. 4B and FIG. 4C are drawings illustrating a method of manufacturing a polarization member (polarizing film) according to an embodiment of the present invention;

FIG. 5A is a graph showing the transmittance and reflectance of a polarizing film according to the mean distance between the electrically conductive particles and the wavelength of light that has a polarization direction perpendicular to the arrangement direction of the electrically conductive particles;

FIG. 5B is a graph showing the transmittance and reflectance of a polarizing film according to the mean distance between the electrically conductive particles and the wavelength of light that has a polarization direction parallel to the arrangement direction of the electrically conductive particles;

FIG. 5C is a graph showing the transmittance and reflectance of a polarizing film according to the mean distance between the electrically conductive particles and the mean width of the electrically conductive particles of light that has a polarization direction perpendicular to the arrangement direction of the electrically conductive particles;

FIG. 5D is a graph showing the transmittance and reflectance of a polarizing film according to the mean distance between the electrically conductive particles and the mean width of the electrically conductive particles of light that has a polarization direction parallel with the arrangement direction of the electrically conductive particles;

FIG. 6 is a layout view of pixels circuits in a liquid crystal display according to an exemplary embodiment of the present invention;

FIG. 7 is a cross-sectional view of the liquid crystal display shown in FIG. 6 taken along section line VII-VII shown in FIG. 6; and

FIG. 8 is a cross-sectional view of the liquid crystal display shown in FIG. 6 taken along section line VIII-VIII shown in FIG. 6.

### DETAILED DESCRIPTION OF THE EXEMPLARY EMBODIMENTS

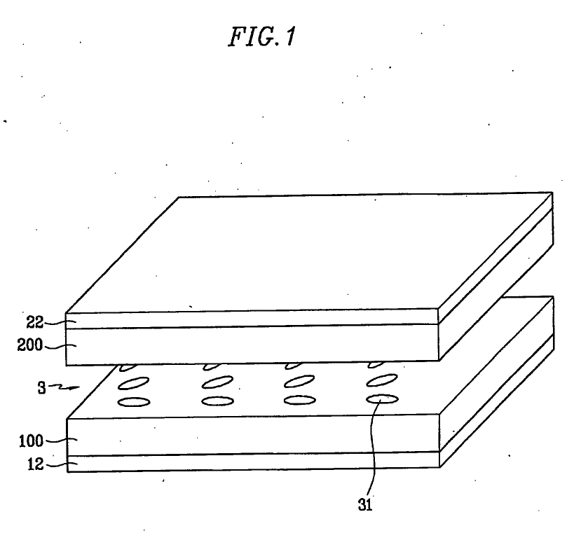

A polarizing film for use in a liquid crystal display according to an embodiment of the present invention will be described in detail with reference to FIGS. 1, 2, 3, 4 and 5.

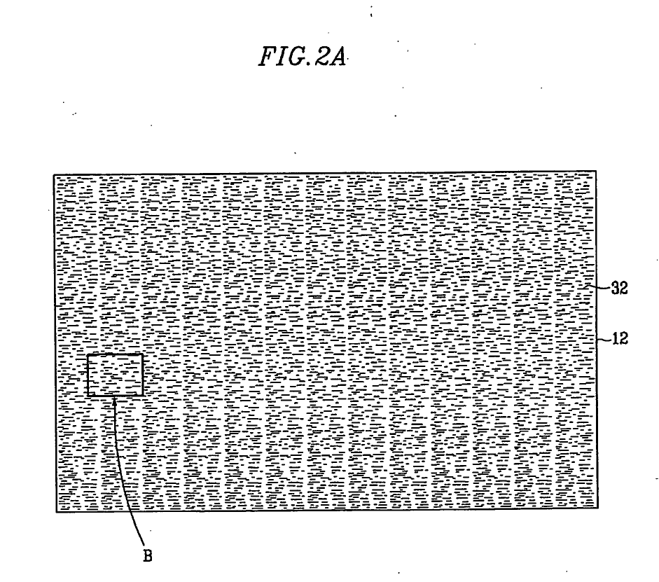

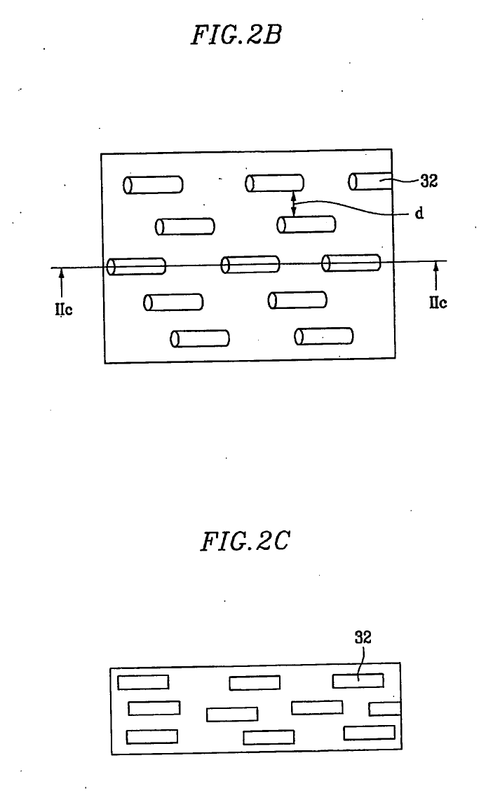

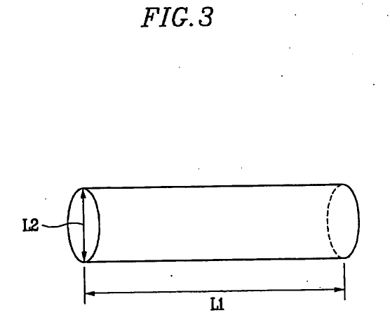

FIG. 1 is a perspective view of the liquid crystal display according to an embodiment of the present invention, FIG. 2A is a top plan view of the polarizing film 12 (or 22) shown in FIG. 1, FIG. 2B is a expanded view of a portion of the polarizing film 12 (or 22) shown in FIG. 2A, FIG. 2C is a cross-sectional view of the polarizing film 12 (or 22) shown in FIG. 2B taken along the section line IIC-IIC, and FIG. 3 is a perspective view of an exemplary electrically conductive particle contained in the polarizing film.

As shown in FIG. 1, a liquid crystal display according to an exemplary embodiment of the present invention includes a lower panel 100, an upper panel 200, a liquid crystal layer 3 interposed between the lower panel 100 and the upper panel 200, and polarizing films 12 and 22 that are provided on outer surfaces of the lower panel 100 and the upper panel 200.

A field-generating electrode (not shown) is formed on an inner surface of at least one of the lower panel 100 and the upper panel 200.

The polarizing films 12 and 22 may alternatively be provided on the inner surfaces of the display panels 100 and 200, or may be provided on only one of the display panels 100 or 200.

Referring to FIG. 2A to FIG. 2C, the polarizing film 12 according to an exemplary embodiment of the present invention includes a ground (electrically conductive) member made from liquid crystal material and a plurality of electrically conductive particles 32.

The liquid crystal material is a nematic liquid crystal that includes elongated liquid crystal molecules that are aligned parallel to each other in their length directions.

The electrically conductive particles 32 are long in one direction and aligned in several lines such that the length directions of the electrically conductive particles 32 coincide with the length directions of the liquid crystal molecules.

The distance (d) between the electrically conductive particles 32, i.e., or the pitch is preferably less than about one third of the wavelength of the incident light, and more preferably, less than about a quarter of the wavelength of the incident light.

The distance (d) (FIG. 2B) is preferably less than about 150 nm, (and, more preferably, between about 50 nm to about 150 nm), because the wavelength of visible light is from about 380 nm to about 780 nm.

Referring to FIG. 3, a electrically conductive particle 32 is approximately cylindrical, and the width of the electrically conductive particle 32 is preferably less than about 0.6 times the mean distance (d) between the electrically conductive particles 32.

The electrically conductive particles 32 preferably include carbon nanotubes or carbon nanofibers. In this case, the length L1 of a electrically conductive particle 32 ranges from about 500 nm to about 900 nm, and the width (diameter) L2 of a electrically conductive particle 32 ranges from about 30 nm to about 90 nm.

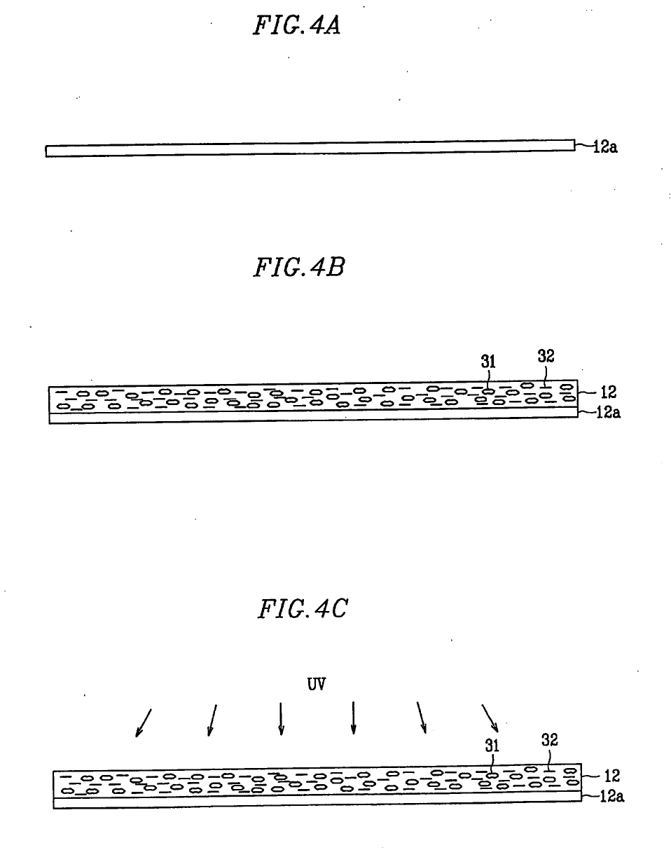

Next, a method of manufacturing a polarizing member according to an embodiment of the present invention will be described in detail with reference to FIG. 4.

FIG. 4 is a cross-sectional view illustrating a method of manufacturing a polarizing member shown in FIG. 2A to FIG. 2C.

First, a base film 12a is prepared as shown in FIG. 4A.

Referring to FIG. 4B, light curable liquid crystal material 31 and electrically conductive particles 32 are mixed and coated on the base film 12a to form a polarizing film 12.

Finally, the polarizing film 12 is hardened as shown in FIG. 4C.

For an example of the hardening process, the polarizing film 12 is pre-baked at a temperature of about 80-100° C., and then irradiated by ultraviolet rays.

Then, the liquid crystal material 31 of the polarizing film 12 photopolymerizes to instantaneously harden such that the liquid crystal molecules are aligned in a direction.

When the liquid crystal material 31 is hardened, the electrically conductive particles 32 are also aligned with the liquid crystal molecules.

Therefore, a plurality of electrically conductive particles 32 aligned in a single direction can be made even without metal film deposition and lithography.

Polarization members (polarizing films) manufactured as described above are attached on outer surfaces of the display panels 100 and 200 of the liquid crystal display.

However, as mentioned previously, instead of attaching the polarization members to the display panels 100 and 200 of the liquid crystal display, the polarizing film 12 may be formed by mixing the liquid crystal material 31 and the electrically conductive particles 32, applying this mixture directly on the inner surfaces or to the outer surfaces of the display panels 100 and 200, and hardening the result (thus forming the polarizing film 12 directly on the display panels 100 or 200).

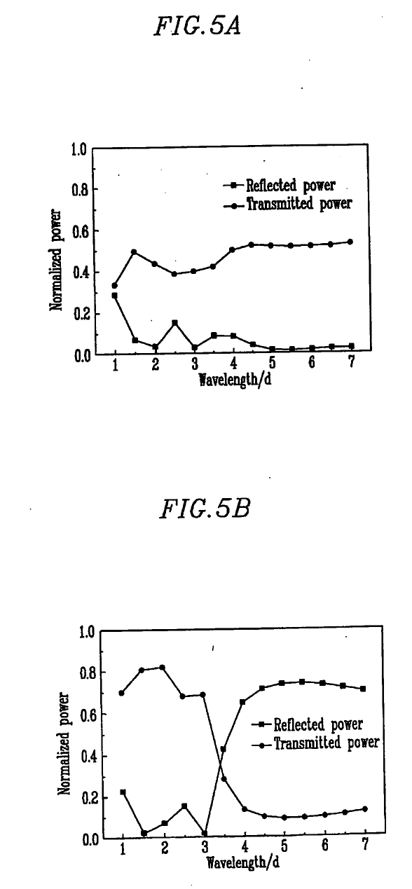

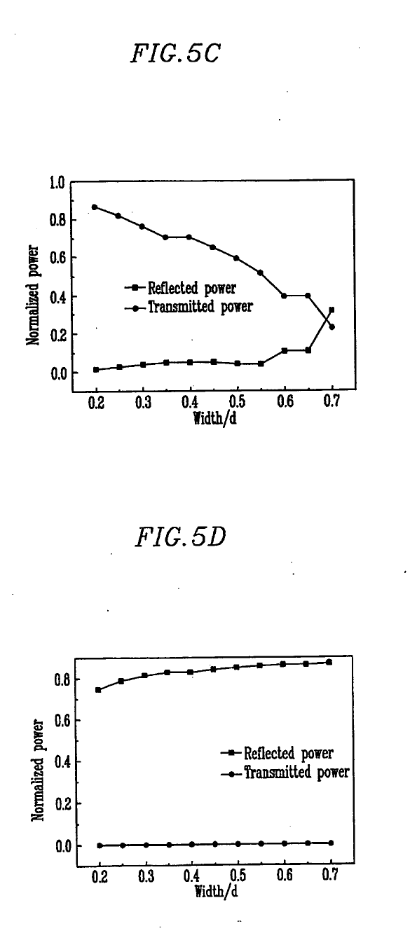

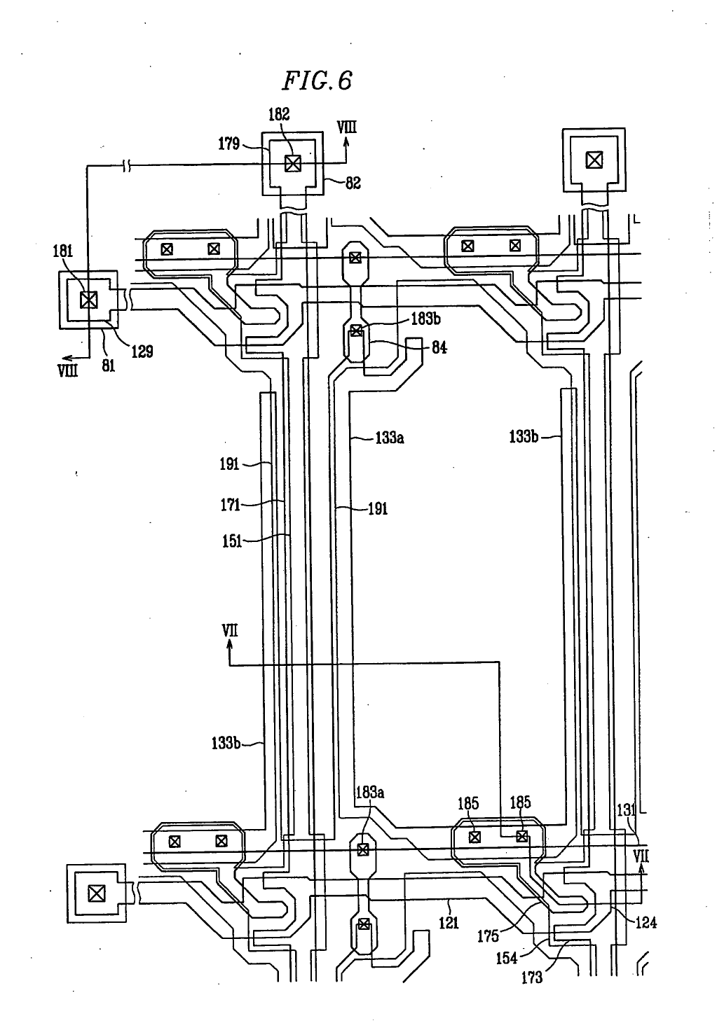

Next, the optical characteristics of the polarizing film 12 or 22 (of FIG. 1), according to an exemplary embodiment of the present invention, will be described with reference to FIG. 5A, 5B, 5C and 5D.

FIG. 5A and FIG. 5B are graphs each showing the transmittance and the reflectance of a polarizing film as a function of wavelength of the incident light divided by the mean distance between the electrically conductive particles. In FIG. 5A, the light has a polarization perpendicular to the alignment direction of the electrically conductive particles. In FIG. 5B, the light has a polarization parallel to the alignment direction of the electrically conductive particles.

The abscissas of FIG. 5A and FIG. 5B represent the wavelength of the light divided by the mean distance (d) between the electrically conductive particles 32 (referred to as “unit wavelength” hereinafter).

Referring to FIG. 5A, though there is no significant variation in the light transmittance according to the wavelength, the reflectance shows dramatic variation. When the unit wavelength is less than about three, the reflectance is irregular and high. The variation of the reflectance decreases as the unit wavelength becomes higher than about three and the reflectance becomes small and uniform as the unit wavelength becomes higher than four.

Therefore, it can be seen from above that when the mean distance (d) between the electrically conductive particles 32 is less than about one third of the wavelength of the incident light, and preferably, less than about a quarter thereof, as illustrated in the present exemplary embodiment, the light that has a polarization perpendicular to the alignment direction of the electrically conductive particles 32 is transmitted well without being reflected.

Referring to FIG. 5B, the light transmittance rapidly decreases as the unit wavelength is more than about three, and the reflectance and the transmittance show a nearly constant value when the unit wavelength is more than about four.

Therefore, it can be seen from above that when the distance between the electrically conductive particles 32 is less than about 1/3.5 of the wavelength of the incident light, and preferably less than about a quarter thereof, the light which has a polarization parallel to the alignment direction of the electrically conductive particles 32 is reflected very well.

FIG. 5C and FIG. 5D are graphs respectively showing the transmittance and the reflectance of a polarizing film as a function of the ratio of the mean width of the electrically conductive particles divided by the mean distance (d) of the electrically conductive particles. In FIG. 5C, the light has a polarization perpendicular to the alignment direction of the electrically conductive particles. In FIG. 5D, the light has a polarization parallel to the alignment direction of the electrically conductive particles.

The abscissas of FIG. 5C and FIG. 5D represent the mean width L2 of the electrically conductive particles 32 divided by the mean distance (d) of the electrically conductive particles 32 (referred to as “unit mean width” hereinafter).

Referring to FIG. 5D, incident light having a polarization parallel to the alignment direction of the electrically conductive particles 32 has a high reflectance and an approximately zero transmittance. Therefore, variation of the unit mean width does not significantly affect the reflectance or transmittance of light with a parallel polarization.

However, referring to FIG. 5C, the reflectance of incident light having a polarization perpendicular to the alignment direction of the electrically conductive particles 32 is almost 0, and it greatly increases as the unit mean width is increased above 0.6. On the other hand, the transmittance of the incident light is smaller as the unit mean width is increased above 0.6.

Therefore, when the mean width of the electrically conductive particles 32 per (divided by) the mean distance (d) between the electrically conductive particles 32 is less than 0.6 in the exemplary embodiment of the present invention, light having a polarization perpendicular to the alignment direction of the electrically conductive particles 32 is transmitted well.

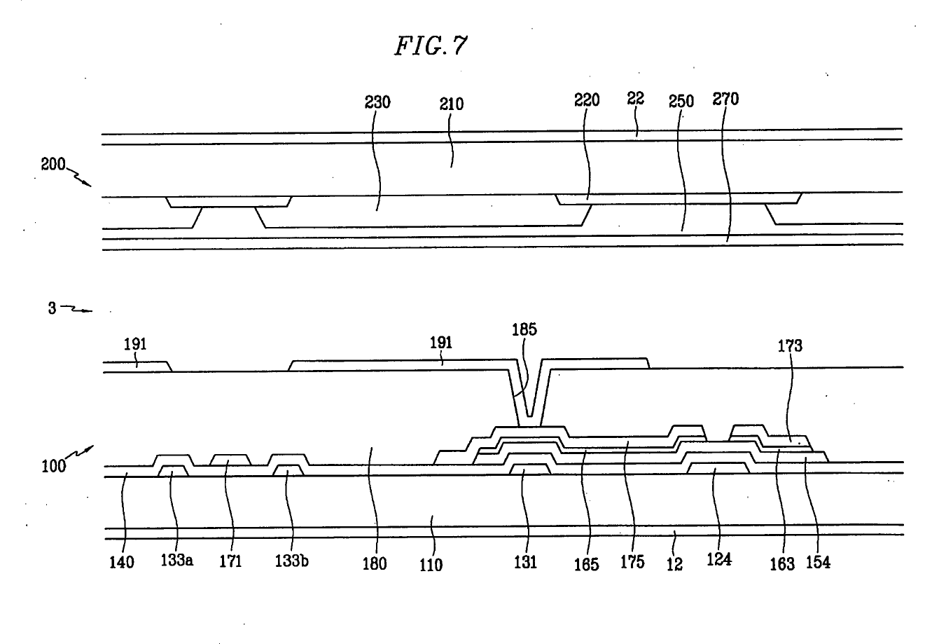

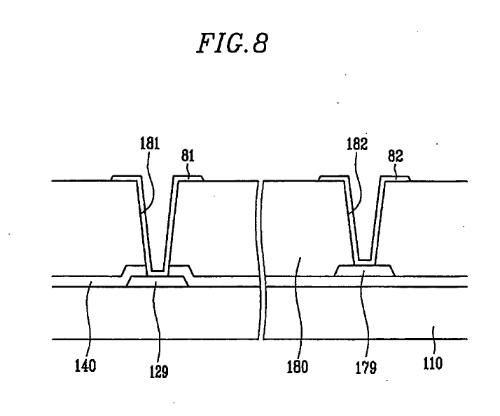

Referring to FIG. 6, FIG. 7 and FIG. 8, a liquid crystal display including a polarizing film according to an exemplary embodiment of the present invention will be described in detail.

FIG. 6 is a layout view of a portion including a pixel of a liquid crystal display according to an exemplary embodiment of the present invention. FIG. 7 is a cross-sectional view of the liquid crystal display shown in FIG. 6 taken along the section line VII-VII shown in FIG. 6, and FIG. 8 is a cross-sectional view of the liquid crystal display shown in FIG. 6 taken along the section line VIII-VIII shown in FIG. 6.

A liquid crystal display according to the present exemplary embodiment includes a thin film transistor (TFT) array panel 100 (lower panel 100 in FIG. 1), a common electrode panel 200 (an upper panel 200 in FIG. 1) confronting the TFT array panel 100, a liquid crystal layer 3 interposed between the panels 100 and 200, and a pair of polarizing films 12, 22 provided on the panels 100 and 200.

First, the TFT array panel 100 will now be described in greater detail.

A plurality of gate lines 121 and a plurality of storage electrode lines 131 are formed on an insulating substrate 110, such as a transparent glass or plastic.

The gate lines 121 transmit gate signals and extend substantially in a transverse (e.g. horizontal) direction.

Each of the gate lines 121 includes a plurality of gate electrodes 124 projecting downward, and (at least) one end portion 129 having a large area for contact with another layer or an external driving circuit.

A gate driving circuit (not shown) for generating the gate signals may be mounted on a flexible printed circuit (FPC) film (not shown), which may be attached to the substrate 110, directly mounted on the substrate 110, or integrated onto the substrate 110.

The gate lines 121 may extend to be directly connected to a driving circuit that may be integrated on the substrate 110.

The storage electrode lines 131 are supplied with a predetermined voltage and each of the storage electrode lines 131 includes a stem extending substantially parallel to the gate lines 121 and a plurality of pairs of storage electrodes 133a and 133b branched from the stems.

Each of the storage electrode lines 131 is disposed between two adjacent gate lines 121, and the stem thereof is close to one of the two adjacent gate lines 121.

Each of the storage electrodes 133a and 133b has a fixed end portion connected to the stem and a free end portion disposed opposite thereto.

The fixed end portion of the storage electrode 133b has a large area, and the free end portion thereof is bifurcated into a linear (straight) branch and a curved branch.

However, the storage electrode lines 131 may have various shapes and arrangements.

The gate lines 121 and the storage electrode lines 131 are preferably made of an Al-containing metal such as Al and an Al alloy, an Ag-containing metal such as Ag and an Ag alloy, a Cu-containing metal such as Cu and a Cu alloy, a Mo-containing metal such as Mo and a Mo alloy, Cr, Ta, or Ti.

However, they may have a multi-layered structure including two conductive films (not shown) having different physical characteristics.

One of the two films is preferably made of a low resistivity metal such as an Al-containing metal, an Ag-containing metal, and a Cu-containing metal for reducing signal delay or voltage drop.

The other film is preferably made of a material such as a Mo-containing metal, Cr, Ta, or Ti, which has good physical, chemical, and electrical contact characteristics with other conductive materials such as indium tin oxide (ITO) or indium zinc oxide (IZO).

Good examples of a combination of the two films are a lower Cr film and an upper Al (alloy) film and a lower Al (alloy) film and an upper Mo (alloy) film.

However, the gate lines 121 and the storage electrode lines 131 may be made of various metals or conductors.

The lateral sides of the gate lines 121 and of the storage electrode lines 131 are inclined relative to a surface of the substrate 110, and the inclination angle thereof ranges about 30-80 degrees.

A gate insulating layer 140 preferably made of silicon nitride (SiNx) or of silicon oxide (SiOx) is formed on the gate lines 121 and the storage electrode lines 131.

A plurality of semiconductor islands (e.g., stripes) 151 preferably made of hydrogenated amorphous silicon (abbreviated to “a-Si”) or of polysilicon are formed on the gate insulating layer 140 (e.g., over the plurality of gate electrodes 124 projecting downward from the gate lines 121).

The semiconductor islands 151 extend substantially in the longitudinal direction and each includes a projection 154 branched out toward its respective gate electrode 124.

The semiconductor islands 151 become wide near the gate lines 121 and the storage electrode lines 131 such that the semiconductor islands 151 cover large areas of the gate lines 121 and the storage electrode lines 131.

A plurality of ohmic contact stripes and islands 161 (163) and 165 are formed on the semiconductor islands 151.

The ohmic contact stripes and islands 161 (163) and 165 are preferably made of n+ hydrogenated a-Si heavily doped with an N-type impurity such as phosphorous, or they may be made of silicide.

Each ohmic contact stripe 161 includes a plurality of projections 163, and the ohmic contact projections 163 and the ohmic contact islands 165 are located in pairs on the projections 154 of the semiconductor islands 151.

The lateral sides of the semiconductor islands 151 and the ohmic contacts 161 and 165 are inclined relative to the surface of the substrate 110, and the inclination angles thereof are preferably in a range of about 30-80 degrees.

A plurality of data lines 171 and a plurality of drain electrodes 175 are formed over the gate insulating layer 140. The plurality of drain electrodes 175 are formed on the ohmic contacts 165.

The data lines 171 transmit data signals and extend substantially in the longitudinal (e.g., vertical) direction perpendicular to the gate lines 121.

Each data line 171 also is perpendicular to the storage electrode lines 131 and runs between adjacent pairs of storage electrodes 133a and 133b.

Each data line 171 includes a plurality of source electrodes 173 projecting toward the gate electrodes 124 and an end (terminal) portion 179 having a large area for contact with another layer or an external driving circuit.

A data driving circuit (not shown) for generating the data signals may be mounted on an FPC film (not shown), which may be attached to the substrate 110, directly mounted on the substrate 110, or integrated onto the substrate 110.

The data lines 171 may extend to be connected to a driving circuit that may be integrated on the substrate 110.

The drain electrodes 175 are separated from the data lines 171 and disposed opposite the source electrodes 173 with respect to the gate electrodes 124.

Each of the drain electrodes 175 includes a wide end portion and a narrow end portion.

The wide end portion overlaps a storage electrode line 131 and the narrow end portion is partly enclosed by a source electrode 173 which has a “J” shape.

A gate electrode 124, a source electrode 173, and a drain electrode 175, along with a projection 154 of a semiconductor island 151, form a TFT having a channel formed in the projection 154 (of the semiconductor island 151) disposed between the source electrode 173 and the drain electrode 175.

The data lines 171 and the drain electrodes 175 are preferably made of a refractory metal, such as Cr, Mo, Ta, Ti, or alloys thereof, and they may have a multilayered structure including a refractory metal film (not shown) and a low resistivity film (not shown).

Good examples of the multi-layered structure are a double-layered structure including a lower Cr/Mo (alloy) film and an upper Al (alloy) film, and a triple-layered structure of a lower Mo (alloy) film, an intermediate Al (alloy) film, and an upper Mo (alloy) film.

However, the data lines 171 and the drain electrodes 175 may be made of various metals or conductors.

The data lines 171 and the drain electrodes 175 have inclined edge profiles, and the inclination angles thereof range about 30-80 degrees to the substrate.

The ohmic contacts 161 and 165 are interposed only between the underlying semiconductor islands 151 and the overlying conductors 171 and 175 thereon, and reduce the contact resistance therebetween.

Although the semiconductor islands (stripes) 151 are narrower than the data lines 171 at most places, the width of the semiconductor islands 151 becomes large near the gate lines 121 and the storage electrode lines 131 as described above, to smooth the profile of the surface, thereby preventing disconnection of the data lines 171.

The semiconductor islands 151 include some exposed portions, which are not covered with the data lines 171 and the drain electrodes 175, such as portions located between the source electrodes 173 and the drain electrodes 175.

A passivation layer 180 is formed on the data lines 171, the drain electrodes 175, and the exposed portions of the semiconductor stripes 151.

The passivation layer 180 is preferably made of an inorganic or organic insulator and it may have a flat top surface.

Examples of the inorganic insulator include silicon nitride and silicon oxide.

The organic insulator may have photosensitivity and a dielectric constant of less than about 4.0.

The passivation layer 180 may include a lower film of an inorganic insulator and an upper film of an organic insulator such that it takes the excellent insulating characteristics of the organic insulator while preventing the exposed portions of the semiconductor stripes 151 from being damaged by the organic insulator.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121, a plurality of contact holes 183a exposing portions of the storage electrode lines 133a near the fixed end portions of the storage electrodes 133a, and a plurality of contact holes 183b exposing the linear branches of the free end portions of the storage electrodes 133a.

A plurality of pixel electrodes 191, a plurality of overpasses 83, and a plurality of contact assistants 81 and 82 are formed on the passivation layer 180.

They are preferably made of a transparent conductor such as ITO or IZO, or a reflective conductor such as Ag, Al, Cr, or alloys thereof.

The pixel electrodes 191 are physically and electrically connected to the drain electrodes 175 through the contact holes 185 such that the pixel electrodes 191 receive data voltages from the drain electrodes 175.

The pixel electrodes 191 of each pixel supplied with the data voltages generate electric fields in cooperation with a common electrode 270 of the opposing common electrode panel 200 supplied with a common voltage, which determine the orientations of the liquid crystal molecules (not shown, of a liquid crystal layer 3 disposed between the two panels 191 and 270) in each pixel.

The polarization of light that passes through the liquid crystal layer 3 in each pixel is changed according to the determined orientation of the liquid crystal molecules in each pixel.

A pixel electrode 191 and the common electrode 270 form a capacitor referred to as a “liquid crystal capacitor,” which stores applied voltages after the TFT of a pixel turns OFF.

A pixel electrode 191 overlaps a storage electrode line 131 including storage electrodes 133a and 133b.

The pixel electrode 191 and a drain electrode 175 connected thereto and the storage electrode line 131 form an additional capacitor referred to as a “storage capacitor,” which enhances the voltage storing capacity of the liquid crystal capacitor of each pixel.

The contact assistants 81 and 82 are connected to the end portions 129 of the gate lines 121 and the end portions 179 of the data lines 171 through the contact holes 181 and 182, respectively.

The contact assistants 81 and 82 protect the end portions 129 and 179 and enhance the adhesion between the end portions 129 and 179 and external devices.

The overpasses 83 cross over the gate lines 121 and they are connected to the exposed portions of the storage electrode lines 131 and the exposed linear branches of the free end portions of the storage electrodes 133b through the contact holes 183a and 183b, respectively, which are disposed opposite each other with respect to the gate lines 121.

The storage electrode lines 131, including the storage electrodes 133a and 133b, along with the overpasses 83 can be used for repairing defects in the gate lines 121, the data lines 171, or the TFTs.

A description of the common electrode panel 200 follows with reference to FIGS. 7 and 8.

A light blocking member 220 is formed on the insulating substrate 210 (e.g., a transparent glass).

The light blocking member 220, referred to as a black matrix, prevents light leakage between the pixels.

The light blocking member 220 has a plurality of openings that face the pixel electrodes 191. The openings may have substantially the same planar shape as the pixel electrodes 191.

Otherwise, the light blocking member 220 may include a plurality of portions facing the data lines 171 or the gate lines 121 on the TFT array panel 100 and a plurality of widened portions facing the TFTs on the TFT array panel 100.

A plurality of color filters 230 are formed on the substrate 210 and the light blocking member 220.

The color filters 230 are disposed substantially in the areas of pixels enclosed by the light blocking member 220, and may extend substantially in the longitudinal direction along the pixel electrodes 191.

Each of the color filters 230 may represent one of the primary colors, red, green, or blue.

An overcoat 250 is formed on the color filters 230 and the light blocking member 220.

The overcoat 250 is preferably made of an (organic) insulator and prevents the color filters 230 from being exposed and provides a flat surface. The overcoat 250 may be omitted.

A common electrode 270 is formed on the overcoat 250. The common electrode 270 is preferably made of a transparent conductive material, such as ITO and IZO.

Alignment layers (not shown) are coated on inner surfaces of the panels 100 and 200.

The polarizing films 12 and 22 are provided on outer surfaces of the panels 100 and 200.

The polarizing films 12 and 22 may alternatively be provided on the inside surfaces of the display panels 100 and 200, such as on the substrate 110, between the other layers.

The polarizing films 12 and 22 have the structure as shown in FIG. 1 to FIG. 3 and can be made (e.g., on the substrate 110) by the method illustrated in FIGS. 4A to 4C.

An axis parallel to (or perpendicular to) a direction in which electrically conductive particles in the polarizing film 12 or 22 are aligned is a polarization axis.

Each of the polarizing films 12 and 22 transmits a polarized component of light, which goes into or comes out of the liquid crystal layer 3, parallel to the polarization axis, and reflects a polarized component perpendicular to the polarization axis, thereby generating a linearly polarized light.

The transmissive axes of the two polarizing films 12 and 22 cross at right angles or are parallel to each other. The variation of the luminance can be effected by controlling the change of the polarization of incident light in each pixel when the incident light passes through the liquid crystal layer 3.

One of the two polarizing films 12 and 22 may be omitted when the LCD is a reflective type LCD.

The liquid crystal layer 3 interposed between the display panels 100 and 200 includes nematic liquid crystal material that has positive dielectric anisotropy.

The liquid crystal molecules of the liquid crystal layer 3 are oriented so that the long axes thereof may be aligned parallel to the surfaces of the display panels 100 and 200.

The direction of the long axes of liquid crystal molecules is helically twisted by about 90 degrees from one display panel 100 to the other display panel 200.

The LCD may further include at least one retardation film (not shown) for compensating the retardation of the liquid crystal layer 3.

The LCD may further include a backlight unit (not shown) supplying light to the retardation film, the display panels 100 and 200, and the liquid crystal layer 3.

Since the polarizing film includes the electrically conductive particles aligned in a predetermined direction, the polarizing film reflects a light component polarized parallel to the alignment direction of the electrically conductive particles and transmits a light component polarized perpendicular to the alignment direction of the electrically conductive particles.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A polarizing film comprising:
a polarizing layer disposed on a base layer; and
a plurality of electrically conductive particles disposed in the polarizing layer.

2. The polarization film of claim 1, wherein the polarizing layer includes a liquid crystal material.

3. The polarization film of claim 1, wherein the electrically conductive particles are spaced apart from each other at a distance of about 50 nm to about 150 nm.

4. The polarization film of claim 1, wherein the electrically conductive particles comprise at least one member selected from the group consisting of carbon nanotubes and carbon nanofibers.

5. The polarizing film of claim 1, wherein the electrically conductive particles are cylindrical.

6. The polarizing film of claim 5, wherein each of the electrically conductive particles has a length equal to about 500 nm to about 900 nm and a width equal to about 30 nm to about 90 nm.

7. A method of manufacturing a polarizing film, the method comprising:
coating a base layer with a mixture including a liquid crystal material and electrically conductive particles to form a polarizing film; and
polymerizing the liquid crystal material in the polarizing film.

8. The method of claim 7, wherein the electrically conductive particles are spaced apart from each other at a distance of about 50 nm to about 150 nm.

9. The method of claim 7, wherein the electrically conductive particles comprise at least one member selected from the group consisting of carbon nanotubes and carbon nanofibers.

10. The method of claim 7, wherein the electrically conductive particles are cylindrical.

11. The method of claim 10, wherein each of the electrically conductive particles has a length equal to about 500 nm to about 900 nm and a width equal to about 30 nm to about 90 nm.

12. A liquid crystal display comprising:
a first panel;
a second panel facing the first panel;
a liquid crystal layer disposed between the first panel and the second panel; and
a first polarizing film including electrically conductive particles.

13. The liquid crystal display of claim 12, further comprising a second polarizing film disposed at the second panel and including electrically conductive particles, wherein the first polarizing film is disposed at the first panel.

14. The liquid crystal display of claim 12, wherein the electrically conductive particles are spaced apart from each other at a distance of about 50 nm to about 150 nm apart.

15. The liquid crystal display of claim 12, wherein the electrically conductive particles comprise at least one member of the group consisting of carbon nanotubes and carbon nanofibers.

16. The liquid crystal display of claim 12, wherein the electrically conductive particles are cylindrical.

17. The liquid crystal display of claim 16, wherein each of the electrically conductive particles has a length equal to about 500 nm to about 900 nm and a width equal to about 30 nm to about 90 nm.

18. The liquid crystal display of claim 12, wherein the first panel comprises a substrate and a plurality of thin films on the substrate, wherein the polarizing film:
directly contacts the substrate;
is disposed between the thin films; or
is disposed on the thin films.

19. The liquid crystal display of claim 18, wherein the plurality of thin films comprise:
a gate line and a data line disposed on the substrate;
a thin film transistor connected to the gate line and to the data line; and
a pixel electrode connected to the thin film transistor.

20. The liquid crystal display of claim 18, wherein the plurality of thin films comprise a common electrode formed on an entire surface of the substrate.

21. The liquid crystal display of claim 20, wherein the plurality of thin films further comprise a light blocking member disposed on the substrate.

22. The liquid crystal display of claim 20, wherein the plurality of thin films further comprise a color filter disposed on the substrate.
